(19) United States
(12) Patent Application Publication
(10) Pub. No.: US 2004/0218508 A1
(43) Pub. Date: Nov. 4, 2004

(54) Data cluster erasure

(76) Inventors: Zhizhang Chen, Corvallis, OR (US); Hung Liao, Corvallis, OR (US); Kenneth Duda, Corvallis, OR (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/426,188

(22) Filed: Apr. 30, 2003

(51) Int. Cl. G11B 7/24

(52) U.S. Cl. 369/275.4; 369/94; 369/288

(57) ABSTRACT

A storage device is provided. The storage device has a stator layer, an emitter layer, and a rotor layer. The rotor layer has a data cluster. The data cluster has a phase change media and a heat source coupled to the data cluster for data cluster erasure. A method of erasing data locations in a data cluster having phase change media is also provided. In a heating action, the phase change media is heated to a temperature which allows interface growth to dominate, rather than nuclei growth. In a cooling action, the phase change media is cooled to reduce polycrystalline structure. Data circuitry for data cluster erasure is also provided.

### INTRODUCTION

It has become difficult to increase the storage density of storage devices such as magnetic hard drives, optical drives, and dynamic randomly accessible memory (DRAM). Many scientists have proposed alternative approaches to increase the storage density. U.S. Pat. No. 5,557,596 (Gibson et al.) discloses an ultra-high-density storage device. This ultra-high density storage device includes at least one field emitter in close proximity to a storage medium, and a micromover for moving the storage medium relative to the field emitter. Each field emitter can generate an electron beam current. The storage medium may have more than one storage area on it, and a field emitter may be assigned to each storage area, or to multiple storage areas. In storing information to the storage device, the power density of an electron beam current generated by the field emitter is adjusted to change the state of the storage area bombarded by the electron beam current. Above certain current thresholds, different physical state changes can be made in the storage area being bombarded by the electron beam current. If two physical states are used, then each location in a storage area would have a binary data potential. Since more than two physical states are possible in a given location, more than binary data levels are possible in each location. In reading information from the device, the power density of the electron beam current may be reduced to generate a signal current from the storage area bombarded by the electron beam current. During reading, the power density is selected to be low enough so that no writing occurs. The magnitude of the signal current depends on the physical state of the storage area. The information stored in the storage area is read by measuring the magnitudes of the signal current. The micromover is able to position the storage medium with respect to the field emitters so that each field emitter can access many storage locations within one or more storage areas. A storage area may also be referred to as a data cluster or a block.

While it may be possible to use the electron beam current to erase one storage location at a time within a given storage area or data cluster, it may also be desirable to erase a plurality of the storage locations on an entire data cluster at one time.

### BRIEF DESCRIPTION OF THE DRAWINGS

FIG. 1 schematically illustrates an embodiment of a storage device in a side cross-sectional view.

FIG. 2 is a cross-sectional top view of the embodied storage device of FIG. 1.

FIG. 3 illustrates one embodiment of actions which may be taken to erase a data cluster on a storage device.

FIG. 4A schematically illustrates an embodiment of a data cluster with data written onto it.

FIG. 4B schematically illustrates an embodiment of a data cluster which has had its data erased.

FIGS. 5-8 schematically illustrate, in a fragmented side cross-sectional view, embodiments of data circuitry for a storage device, such as the storage device of FIG. 1.

### DETAILED DESCRIPTION OF THE PREFERRED EMBODIMENTS

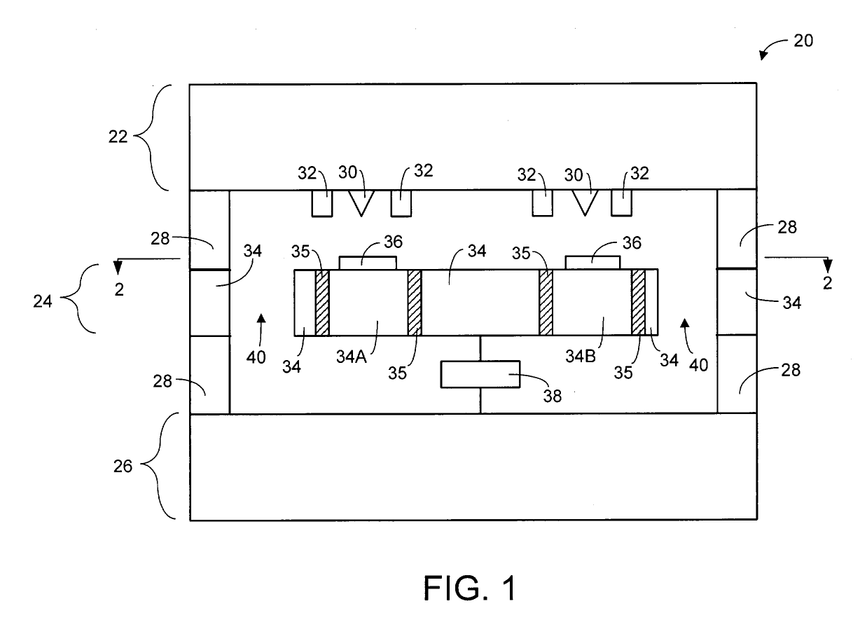

FIG. 1 schematically illustrates an embodiment of a storage device 20 in a side cross-sectional view. The storage device 20 has three layers which are bonded together, including an emitter layer 22, a rotor layer 24, and a stator layer 26. Bonding surfaces 28 may be constructed as part of either of the layers 22, 24, 26 prior to bonding, or may be separate elements. The bonding surfaces 28 may also be conductive or contain conductive traces in order to allow electrical coupling between the layers 22, 24, 26. The emitter layer 22 has one or more field emitters 30, and a gate 32 for each field emitter 30. The field emitters 30 have a sharp point with a radius of curvature sized such that when a preselected potential difference is applied between a field emitter 30 and its corresponding gate 32, an electron beam current is released from the point of the field emitter 30 towards the rotor layer 24. Although the field emitters 30 are illustrated as having a point, field emitters with other shapes may be desirable, such as flat field emitters, depending on a given application.

The rotor layer 24 has a substrate 34, typically made of a crystalline structure, such as silicon which has been doped to be conductive. The substrate may be divided into areas of isolated substrate 34A, 34B by areas of insulating dielectric material 35. Patches of phase change media 36 may be coupled to the isolated substrates 34A, 34B. These isolated patches of phase change media 36 may also be known as data clusters 36, since data may be stored in data locations on a given patch of phase change media 36 as previously discussed. The stator layer 26 and the rotor layer 24 interact with each other through an actuation mechanism, here schematically illustrated as actuator 38. Although actuator 38 is schematically illustrated as physically coupled between the stator layer 26 and the rotor layer 24, no physical connection is necessary. While piezoelectric actuators, and the like, may be physically coupled between the stator layer 26 and the rotor layer 24, non-contact methods for actuation may be used. For example, electrodes may be formed on the stator layer 26 and on the rotor layer 24, facing each other, and may be aligned such that varying voltages to certain electrodes serve to move the rotor layer 24 as the electrodes position themselves within the resultant electric fields. FIG. 1 illustrates the actuator 38 schematically for ease of understanding, but it should be understood that all contact and non-contact methods of moving the rotor layer 24 may be compatible with storage devices.

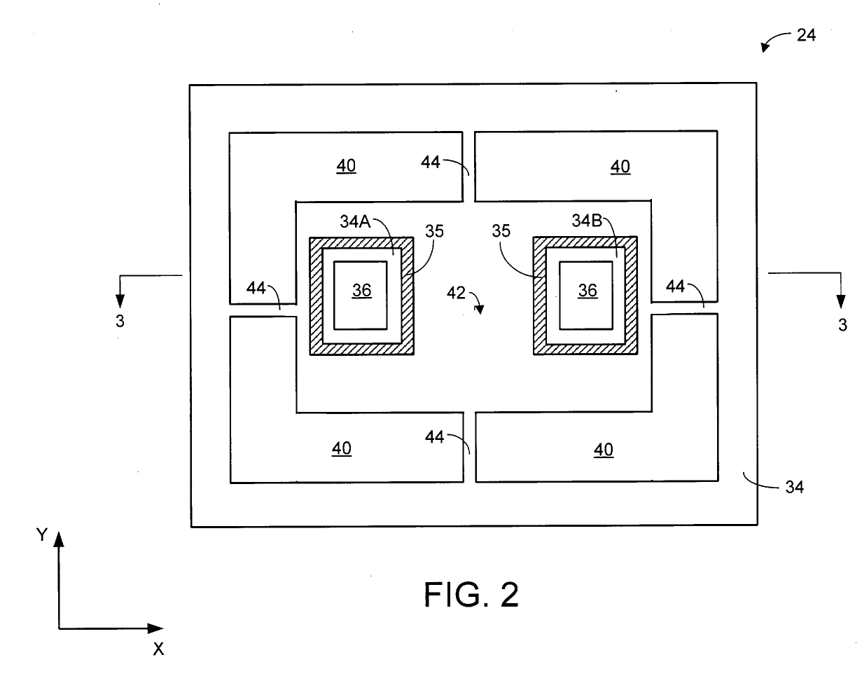

The rotor layer 24 defines a series of gaps 40 which allow a portion of the rotor layer 24 to be moved by the actuator 38. The gaps 40 may be better seen in FIG. 2. FIG. 2 is a cross-sectional top view of the embodied storage device 20 of FIG. 1, taken along section line 2-2, and showing the rotor layer 24. The moveable portion of the rotor layer 24 is often referred to as a micromover 42. The micromover 42 is defined by the gaps 40 and beams 44. Beams 44 are manufactured thin enough to allow them to flex, thereby allowing movement of the micromover 42 back and forth along the X-axis and the Y-axis, or combinations thereof, when actuated by the actuator 38. The micromover 42 has patches of phase change media 36 in different locations.

Referring once again to FIG. 1, each field emitter 30 is positioned over a corresponding patch of phase change media 36. In other embodiments, one field emitter 30 may be allocated for several patches of phase change media 36. Recall that each patch of phase change media 36 may also be referred to as a data cluster 36. When the field emitter 30 is positioned in a particular location over a data cluster 36, the emitter 30 is said to be over a storage location. When an electron beam current is released from the field emitter 30 towards the rotor layer 24, it will contact a storage location in a data cluster 36. The storage density of each data cluster 36 may be determined by the number of unique storage locations which the micromover 42 may be moved to. The number of unique storage locations are determined in great part by the spot size of the electron beam. For more information on methods of moving a micromover 42, writing with field emitters 30, focusing electron beams to improve storage density, as well as different types of phase change media 36, reference can be had to U.S. Pat. No. 5,557,596, the specification of which is hereby formally incorporated by reference.

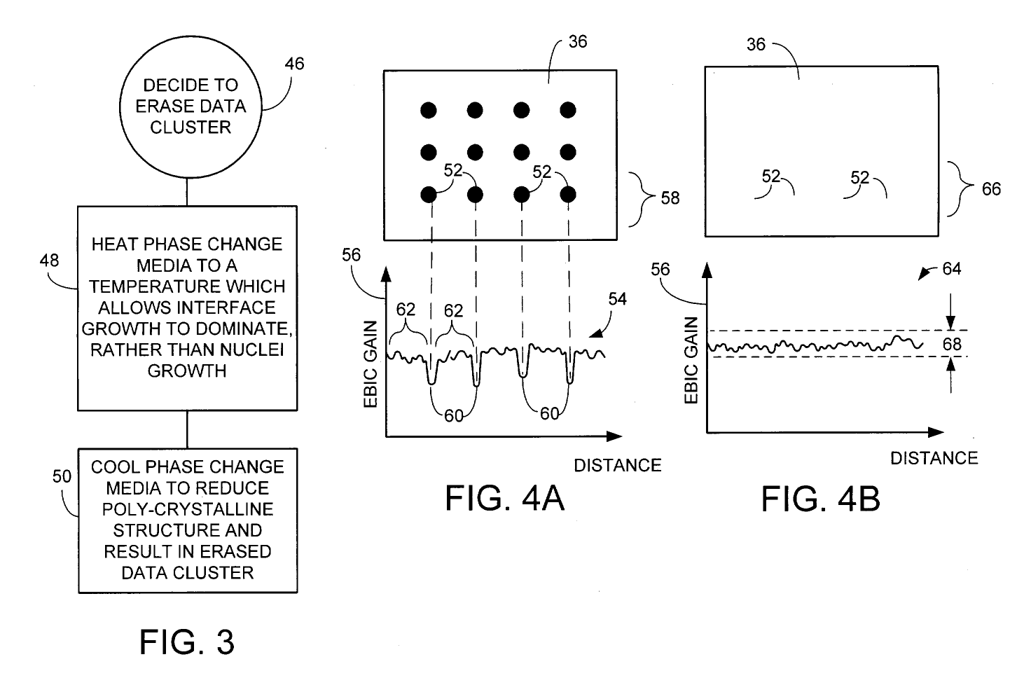

Recent experimentation has shown that it is possible to erase multiple data locations within a data cluster 36 in one shot without using the electron beam current. FIG. 3 illustrates an embodiment of actions which may be taken to erase a data cluster 36 on a storage device. Once a decision has been made 46 to erase a data cluster 36, the phase change media 36 (where the data is stored in the data cluster) is heated 48 to a temperature which allows interface growth to dominate, rather than nuclei growth. The phase change media 36 may then be cooled 50 to reduce instances of polycrystalline structure and result in an erased data cluster 36. In heating 48 the phase change media 36, the temperature attained by the phase change media 36 seems to be more important than the duration over which the heat is applied. For example, a predicted recrystalization time is likely to be approximately one-hundred microseconds for an InSe phase change media 36 which has been heated to approximately six-hundred degrees Celsius over a period of twenty to fifty nanoseconds. This example is not meant to be restrictive of phase change media type, temperature, or time in any sense; rather, it is meant to be illustrative of the utility of such an erasure technique, as it can occur reasonably quickly.

FIGS. 4A and 4B schematically illustrate an embodiment of a data cluster 36 which may be used to illustrate the effect of data cluster erasure. The data cluster 36 of FIG. 4A has data information stored on it, here represented as dots in storage locations 52. Data plot 54 graphs an electron beam induced current (EIBC) gain 56 for a single row 58 of data on the data cluster 36. The data state at the storage locations 52 in row 58 may be seen on the plot 54 as regions having a reduced 60 EIBC gain, versus the surrounding regions 62 which are predominantly crystalline and which have not been made amorphous through a writing process. After following the procedure of FIG. 3 to heat the data cluster 36 to a temperature which allows interface growth to dominate, rather than nuclei growth, and then cooling the data cluster 36, the data cluster 36 will effectively be erased, as is schematically illustrated in FIG. 4B. Ideally, the data cluster should have recrystalized such that the data locations 52 will not appear different than the surrounding areas of the data cluster 36. Data plot 64 graphs an EBIC gain 56 for a single row 66 of data locations 52 on the data cluster 36 in FIG. 4B. Notice that there may be a certain noise level 68 which the EBIC gain 56 signal reports. The erasure process should preferably result in an EBIC gain 56 signal which falls within the typical or expected noise range 68 of the phase change media 36.

For some embodiments, it may be desirable to adjust the electron beam writing power so that the volume of the amorphous written-bit at each data location 52 is minimized or reduced, yet still discernable from the noise level 68. By reducing the volume of the amorphous written bit, the ratio of the surrounding crystalline interface to the volume of the bit will be increased, and therefore it will be easier for full recrystalization from the interface inward into the data bit upon erasure. Additionally, small written data bits contain fewer nuclei sites, which should help to realize full recrystalization of the amorphous mark.

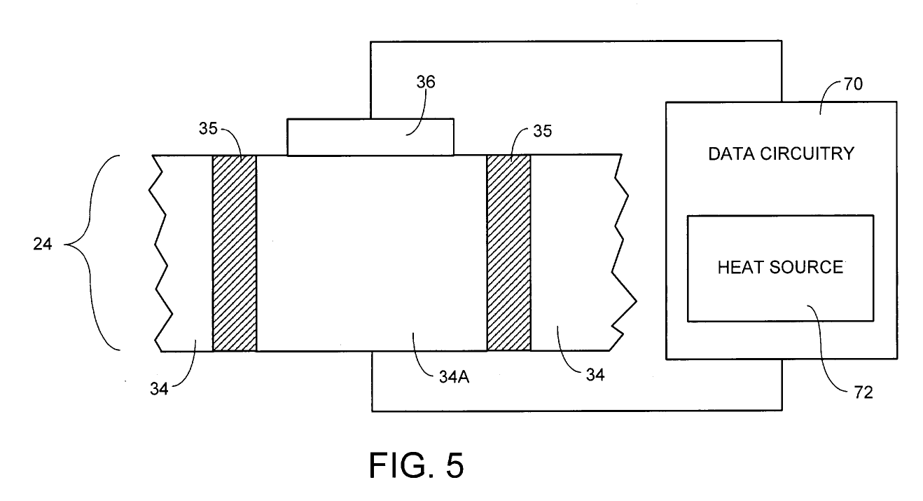

FIG. 5 schematically illustrates, in a fragmented side cross-sectional view, one embodiment of data circuitry 70 for a storage device, such as the storage device 20 of FIG. 1. In FIG. 5, the only layer of the storage device 20 which is shown is the rotor layer 24, here shown in a fragmented cross-sectional front view taken along cross-sectional line 3-3 from FIG. 2. This is done for ease of explanation, however, it should be understood that the storage device 20 has three layers 22, 24, 26 which are bonded together as discussed with respect to FIG. 1. The data circuitry 70 may be responsible for reading, writing, and/or erasing data from the phase change media 36. If the data circuitry 70 includes the function of erasing a plurality of data locations at one time within the data cluster 36, using a method like the method embodied in FIG. 3 and discussed above, then a heat source 72 may be coupled to the data circuitry 70, and therefore coupled to the phase change media 36. The coupling of the heat source 72 to the phase change media 36 may be direct or indirect.

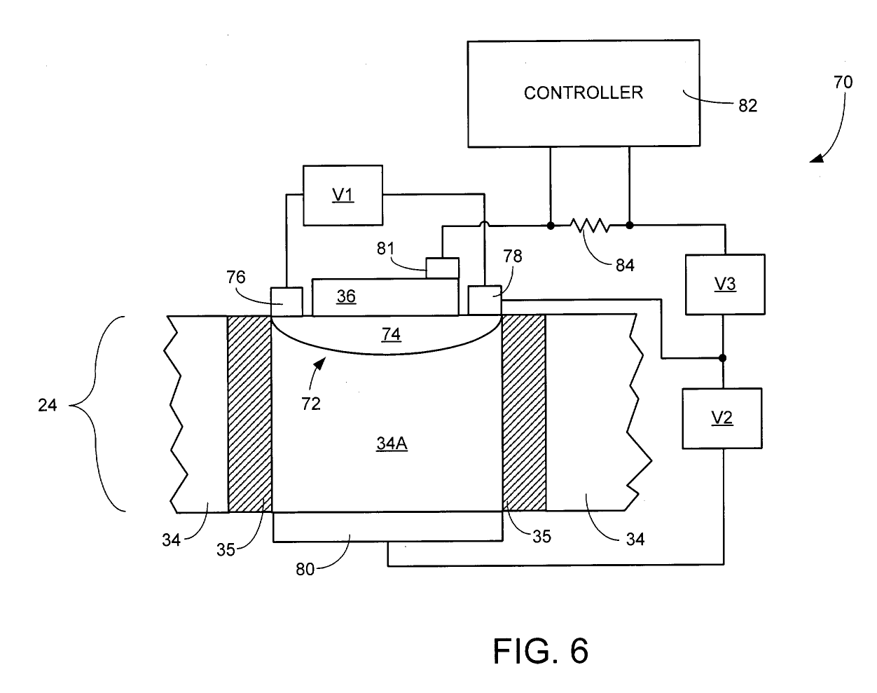

FIG. 6 illustrates, in a fragmented side cross-sectional view, one embodiment of data circuitry 70 for a storage device, such as the storage device 20 of FIG. 1. The substrate 34A may be constructed of a doped silicon structure, such as an n-type silicon structure. A p-type well 74 may be implanted in the substrate 34A. An n-type phase change media 36 is deposited onto, or otherwise coupled to the p-type well 74. A first voltage source, V1, may be coupled to the p-type well 74 in at least two locations, such that the voltage V1 may cause a current to flow through the p-type well 74. In the embodiment of FIG. 6, the first voltage source V1 is coupled to the p-type well 74 via contacts 76 and 78. As a voltage V1 (or current in other embodiments) is applied across the p-type well 74, the p-type well 74 acts as a heater resistor (an example of a heat source 72), and the voltage V1 can be varied to achieve a desired temperature in the phase change media 36. While the phase change media 36 is directly coupled to the p-type well 74 in this embodiment, other embodiments may have a p-type well heater resistor 74 which is indirectly coupled to the phase change media 36, for example in the case where a portion of the substrate 34A falls between the two.

In the embodiment of FIG. 6, when it is desired to erase the portion of the data cluster 36 which may be heated by the p-type well heater resistor 74, then an appropriate voltage V1 may be applied, and temperature created, according to the guidelines previously discussed with regard to FIGS. 3-4B. In order to ensure that a heater current flows through the p-well heater resistor 74 (and not through the substrate 34A), a second voltage V2 may be coupled to the substrate 34A, such that V2 is greater than V1, thereby making sure that the p-n junction between the p-type well 74 and the n-type silicon substrate 34A is reverse-biased. In this embodiment, the second voltage V2 is coupled to the substrate 34A via a contact 80. The opposite end of voltage V2 may be coupled to the p-type well 74, here via contact 78. A third voltage, V3, may be coupled between the phase change media 36 (here, at contact 81) and the p-type well 74 (here, at contact 78). A controller 82 may read the voltage and/or current flowing through the phase change media 36 during a write or read procedure from the electron beam, provided p-type well contacts 76 and 78 are at the same potential (for example, by bypassing V1 during a read/write procedure). In this embodiment, the controller 82 is able to read a voltage proportional to the current in the phase change media 36 by being coupled across a resistor 84 located between the third voltage source V3 and the phase change media 36. The controller 82 may be an application-specific integrated circuit (ASIC), a microprocessor, analog components, digital components, or any combination thereof. The dielectric isolation areas 35 may be used to provide thermal isolation as well as electrical isolation, thereby preventing heat from a local heat source 72 from erasing or corrupting another data cluster 36.

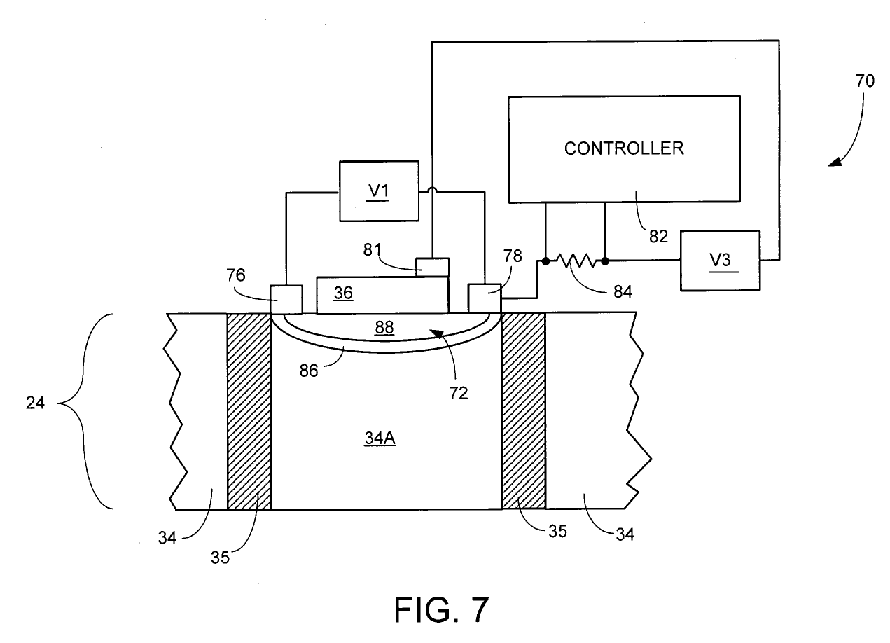

FIG. 7 illustrates, in a fragmented side cross-sectional view, one embodiment of data circuitry 70 for a storage device, such as the storage device 20 of FIG. 1. The substrate 34A may be constructed of a doped silicon structure, such as an n-type silicon structure. Oxygen may be implanted into the silicon substrate 34A to form a SiO₂ barrier layer 86. A doped semiconductor well 88 may be implanted in the substrate 34A, such that the doped well 88 is isolated from the n-type substrate 34A by the barrier layer 86. Because the barrier layer 86 is present, the doped semiconductor well 88 may either be an n-type well, or a p-type well. A phase change media 36 is deposited onto, or otherwise coupled to the semiconductor well 88. A first voltage source, V1, may be coupled to the semiconductor well 88 in at least two locations, such that the voltage V1 may cause a current to flow through the semiconductor well 88. In the embodiment of FIG. 7, the first voltage source V1 is coupled to the semiconductor well 88 via contacts 76 and 78. As a voltage V1 (or current in other embodiments) is applied across the semiconductor well 88, the well 88 acts as a heater resistor (an example of a heat source 72), and the voltage V1 can be varied to achieve a desired temperature in the phase change media 36. While the phase change media 36 is directly coupled to the semiconductor well 88 in this embodiment, other embodiments may have a semiconductor well heater resistor 88 which is indirectly coupled to the phase change media 36, for example in the case where a portion of the substrate 34A falls between the two.

In the embodiment of FIG. 7, when it is desired to erase the portion of the data cluster 36 which may be heated by the semiconductor well heater resistor 88, then an appropriate voltage V1 may be applied, and temperature created, according to the guidelines previously discussed with regard to FIGS. 3-4B. In this embodiment, a reverse-biasing voltage, such as voltage V2 from FIG. 6, is not required to ensure that a heater current flows through the semiconductor well heater resistor 88 as opposed to through the substrate 34A since the barrier layer 86 will prevent current flow from the semiconductor well 88 to the substrate 34A. A voltage, V3, may be coupled between the phase change media 36 (here, at contact 81) and the semiconductor well 88 (here, at contact 78). A controller 82 may read the voltage and/or current flowing through the phase change media 36 during a write or read procedure from the electron beam, provided semiconductor well contacts 76 and 78 are at the same potential (for example, by bypassing V1 during a read/write procedure). In this embodiment, the controller 82 is able to read a voltage proportional to the current in the phase change media 36 by being coupled across a resistor 84 located between the third voltage source V3 and the semiconductor well 88. The controller 82 may be an application-specific integrated circuit (ASIC), a microprocessor, analog components, digital components, or any combination thereof. The dielectric isolation areas 35 may be used to provide thermal isolation as well as electrical isolation, thereby preventing heat from a local heat source 72 from erasing or corrupting another data cluster 36.

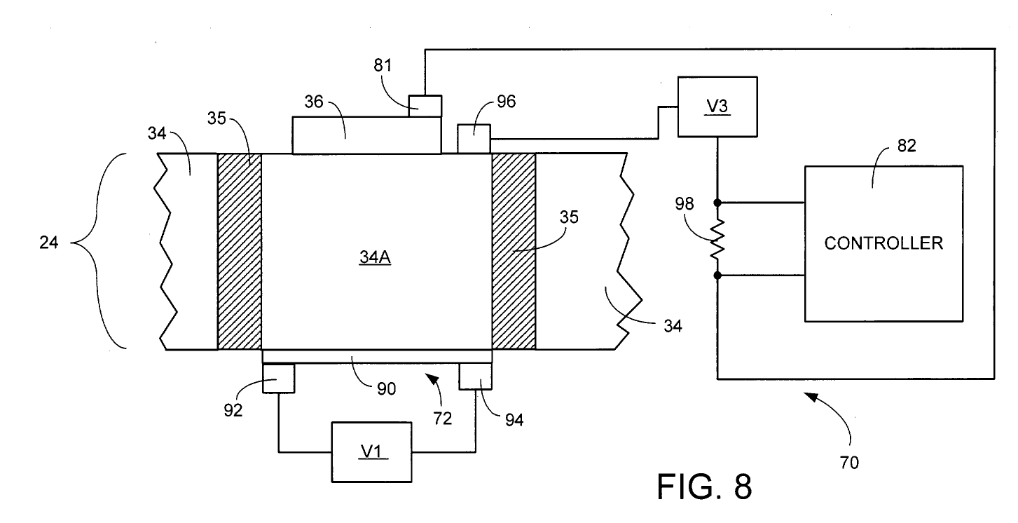

FIG. 8 illustrates, in a fragmented side cross-sectional view, one embodiment of data circuitry 70 for a storage device, such as the storage device 20 of FIG. 1. The substrate 34A may be constructed of a doped silicon structure, such as an n-type silicon structure. An n-type phase change media 36 is deposited onto, or otherwise coupled to the substrate 34A. A thin-film resistor 90 (an example of a heat source 72) is also coupled to the substrate 34A. A first voltage source, V1, may be coupled between contacts 92, 94 which provide current to the thin-film resistor 90. As the voltage V1 (or current in other embodiments) is applied across the thin-film resistor 90, the thin-film resistor 90 heats up and the voltage V1 can be varied to achieve a desired temperature in the phase change media 36. While the phase change media 36 is indirectly coupled to the thin-film resistor 90 in this embodiment, other embodiments may have a thin-film resistor 90 which is directly coupled to the phase change media 36, for example in the case where at least a portion of the thin-film resistor 90 comes into contact with at least a portion of the phase change media 36.

In the embodiment of FIG. 8, when it is desired to erase the portion of the data cluster 36 which may be heated by the thin-film heater resistor 90, then an appropriate voltage V1 maybe applied according to the guidelines previously discussed with regard to FIGS. 3-4B. A voltage, V3, may be coupled between the phase change media 36 (here, at contact 81) and the substrate 34A (here, at contact 96). A controller 82 may read the voltage and/or current flowing through the phase change media 36 during a write or read procedure from the electron beam, provided thin-film resistor 90 is not heated to a temperature which will affect the data. One way of ensuring thin-film resistor 90 will not affect a read or write operation is to make sure thin-film resistor contacts 92 and 94 are at the same potential. In this embodiment, the controller 82 is able to read a voltage proportional to the current in the phase change media 36 by being coupled across a resistor 98 located between the third voltage source V3 and the phase change media 36. The controller 82 may be an application-specific integrated circuit (ASIC), a microprocessor, analog components, digital components, or any combination thereof. The dielectric isolation areas 35 may be used to provide thermal isolation as well as electrical isolation, thereby preventing heat from a local heat source 72 from erasing or corrupting another data cluster 36.

Although the embodied storage devices were illustrated as having one electron field emitter 30 for each data cluster 36, it should be understood that a single field emitter 30 can be used to access more than one data cluster, depending on a particular storage device design, and these types of storage devices and their equivalents are deemed to be within the scope of the claims below. The embodiments for data cluster erasure described herein, and their equivalents, maybe used to erase all or a portion of a data cluster, depending on how the heat source is coupled to the data cluster. While the embodiments for data cluster erasure, and their equivalents, described herein have illustrated a single heat source per data cluster, embodiments with multiple heat sources (which may, for example be segmented, mutually exclusive, or overlapping) are also intended to be within the scope of this disclosure. The embodiments included herein are not intended to be limiting to the claims below. For example, it is often possible to use an n-type semiconductor in lieu of a p-type semiconductor, provided you have the freedom to reverse biases applied to the semiconductor, and visa versa. It should be apparent that a variety of other structurally and functionally equivalent modifications and substitutions may be made to implement data cluster erasure and data circuitry according to the concepts covered herein, depending upon the particular implementation, while still falling within the scope of the claims below.

We claim:

1. A storage device, comprising
a stator layer;
an emitter layer; and
a rotor layer, wherein the rotor layer comprises:
a data cluster comprising a phase change media; and
a heat source coupled to the data cluster for data cluster erasure.

2. The storage device of claim 1, wherein the heat source comprises a semiconductor well.

3. The storage device of claim 2, wherein the semiconductor well comprises a p-type well.

4. The storage device of claim 2, wherein the semiconductor well comprises an n-type well.

5. The storage device of claim 1, wherein the heat source comprises a thin-film resistor.

6. The storage device of claim 1, wherein the rotor layer is bonded between the emitter layer and the stator layer.

7. The storage device of claim 6, wherein the stator layer and the rotor layer are coupled together by an actuator.

8. The storage device of claim 7, wherein the actuator further comprises a piezo-electric device to move a micromover portion of the rotor layer.

9. The storage device of claim 7, wherein the actuator further comprises a non-contact means for moving a micromover portion of the rotor layer.

10. A storage device, comprising:
means for electrically isolating a plurality of data clusters, of phase change media coupled to a conductive substrate, from each other;
means for reading a signal from each of the data clusters based on currents which flow from the phase change media to the conductive substrate in each data cluster; and
means for applying heat to the phase change media so that data stored on the phase change media is erased.

11. The storage device of claim 10, wherein the means for electrically isolating a plurality of data clusters further provides means for thermally isolating the data clusters from each other.

12. The storage device of claim 10, further comprising means for thermally isolating the data clusters from each other.

13. A method of erasing data locations in a data cluster having phase change media, comprising:
heating the phase change media to a temperature which allows interface growth to dominate, rather than nuclei growth; and
cooling the phase change media to reduce polycrystalline structure.

14. The method of claim 13, further comprising:
prior to heating the phase change media, writing a data bit having a volume onto the phase change media, wherein the volume of the data bit is sized to increase a ratio of a surrounding crystalline interface to the volume of the data bit.

15. Data circuitry for a storage device having a phase change media, comprising:
a controller; and
a heat source coupled to the phase change media.

16. The data circuitry of claim 15, wherein the heat source is directly coupled to the phase change media.

17. The data circuitry of claim 15, wherein the heat source is indirectly coupled to the phase change media.

18. The data circuitry of claim 15, wherein the heat source comprises a resistive element which is selected from the group consisting of a doped semiconductor well, a p-type well, and a thin-film resistor.

19. A storage device, comprising
a substrate;
a phase change media directly or indirectly coupled to the substrate;
data circuitry coupled to the phase change media and the substrate, the data circuitry comprising a heat source.

20. The storage device of claim 19, wherein the heat source has a resistive element selected from the group consisting of a semiconductor well, a p-type well, and a thin-film resistor.

21. The storage device of claim 19, further comprising a barrier layer separating the heat source from the substrate.

22. The storage device of claim 19, wherein the heat source comprises a semiconductor well formed in the substrate, coupled to the phase change media, and configured to receive a first voltage across the semiconductor well for the purpose of generating a current in the semiconductor well which creates heat that is transferred to the phase change media.

23. The storage device of claim 22, wherein the semiconductor well and the phase change media are configured to receive a second voltage.

24. The storage device of claim 23, wherein the second voltage is greater than the first voltage.

25. The storage device of claim 19, wherein the heat source comprises a thin-film resistor directly or indirectly coupled to the phase change media, and configured to receive a first voltage across the thin-film resistor for the purpose of generating a current in the thin-film resistor which creates heat that is transferred to the phase change media.
